(19) United States
(12) Patent Application Publication
(10) Pub. No.: US 2014/0196583 A1
(43) Pub. Date: Jul. 17, 2014

(54) TOOL CHUCKING FIXTURE

(71) Applicant: Joel Judas, Unterensingen (DE)

(72) Inventor: Joel Judas, Unterensingen (DE)

(21) Appl. No.: 13/741,203

(22) Filed: Jan. 14, 2013

(51) Int. Cl. B23B 29/24; B23B 25/06

(52) U.S. Cl. CPC B23B 29/248; B23B 25/06
USPC 82/121; 82/152

(57) ABSTRACT

A tool chucking fixture having a tool holder that receives a tool and is intended for insertion into a receptacle of a tool carrier, which tool carrier is embodied with a corresponding receptacle. To compensate for position errors of the tool holder relative to the tool carrier, at least two adjusting elements, located separately from one another and adjustable via associated adjusting means, are provided on the tool holder, while the tool carrier has at least two contact points, associated with the adjusting elements of the tool holder used, at which points the adjusting elements rest with a precise fit.

### FIELD OF THE INVENTION

The invention relates to a tool chucking fixture, having a tool holder that receives a tool and is intended for insertion into a receptacle of a tool carrier, in particular of a Lathe, in which the tool holder and the tool carrier have Dearing faces associated with one another and devices for securing the tool holder to the tool carrier, and positioning means for positionally precise adjustment of the tool holder relative to the receiving bore are provided.

### BACKGROUND OF THE INVENTION

For instance, in CNC turning centers with movable tool carriers in the form of tool turret disks and the like, tool holders are used to receive turning tools, drilling tools, milling tools, or other tools required for manufacture, which are inserted into suitable receptacles of the tool carrier. Automatic tool changing systems are often used, which depending on the progress of machining either insert tool holders with preadjusted tools or replace same.

Tool holders with a cylindrical shaft are standardized under German Industrial Standard DIN 69880. They can be arranged for fixed or revolving tools. It is also known to provide the tool holder with a securing flange, which when the tool holder is inserted into the receptacle rests on the tool carrier and is firmly screwed to it, so that the tool holder is rigidly joined to the tool carrier. For positional fixation of the tool holder on the tool carrier, an additional fitted keyway, usually provided centrally to the center of the receiving bore, is also used in the industry, with a corresponding fitting key engaging it on the shaft of the tool holder. Often, there is also a fixation bore, radially spaced apart from the axis of the receiving bore, on the tool carrier or the tool holder, into which bore a fitting pin is inserted, which in particular fixes the angular position of the tool holder relative to the tool carrier.

The fundamental problem of this or similar known ways of positionally fixing a tool holder that is inserted by its cylindrical shaft into a receiving bore of the tool carrier is that production variations in the tool holder and the tool carrier and the fitting play, required for changing the tool holder, between the shaft and the wall of the receiving bore cause a certain positional imprecision of the machining tool inserted into the tool holder. This positional imprecision is especially problematic with respect to the angular position of tools located radially to the axis of the receiving bore, because for relatively long tools, they lead to considerable imprecision in machining. In CNC (Computerized Numerical Control) turning centers designed for high machining precision especially, the positional precision of the tool holder relative to the tool carrier does not as a rule meet what is required of it, unless additional provisions are taken. Readjustment of the tool holder inserted into the receptacle is therefore usually necessary. This is also true for tool holders that are made without a shaft and are simply screwed firmly or otherwise secured to the tool carrier.

Such readjustments of tool holders on the machine, however, are time-consuming and increase so-called setup times considerably. Moreover, the tool holders cannot be preadjusted in such a way that they can be changed with the requisite (very low) positional tolerance. This becomes an especially great disadvantage in automatic tool changing systems.

To provide some help here, tool chucking fixtures have already become known in the industry in which provisions are made on the tool holder in the tool carrier to enable adjusting the tool holder relative to the associated receiving bore of the tool carrier, in particular with a precise angular position, by way of adjusting elements. For this purpose, it is known to mount a bar, which has a V-shaped; dimensionally accurate recess, on the housing of the tool holder using an adjusting gauge and to screw an associated counterpart firmly to the turret disk, with the counterpart engaging the recess of the V-strip when the tool holder is inserted. Other adjusting elements are embodied in the form of an eccentric bolt, which is inserted into a bore of the tool carrier that is spaced radially apart from the axis of the receiving bore, and which protrudes into a corresponding bore or receptacle of the tool holder. The eccentric bolt can also be embodied with spread-type clamping and can for instance be adjusted via a wrench attachment or by adjusting screws that are accessible from outside and engage the eccentric bolt next to its axis.

All of these devices for adjusting the angular position of a tool holder relative to the tool carrier have certain disadvantages in use, either because they are not simple enough and sensitive enough to use or because they make undesirably high demands in terms of the attentiveness of the workers, or they require provisions to be made in the tool carrier, and especially the turret disk and/or the tool holder, which for instance additional space and are problematic for that reason.

### OBJECTS AND SUMMARY OF THE INVENTION

The object of the invention is therefore to create a tool chucking fixture with a tool holder, which receives a tool and is intended for insertion into a receptacle of a tool carrier, for instance a turret disk, that makes it possible without disruptive or excessively complicated provisions on the tool carrier and without undesirably high effort of use to assure close-tolerance positional fixation of the tool holder relative to the tool carrier, so that the tool holder in particular can be preadjusted or precalibrated and that a play-free transmission of the angular position is assured.

This and other objects are attained in accordance with one aspect of the invention directed to a tool chucking fixture, having a tool holder that receives a tool and is intended for insertion into a receptacle of a tool carrier, in particular of a lathe, in which the tool holder and the tool carrier have bearing faces associated with one another and devices for securing the tool holder to the tool carrier, and positioning means for positionally precise adjustment of the tool holder relative to the receiving bore are provided. The tool holder (3) has at least two adjusting elements (26), guided without play and spaced apart from one another. At least two contact points (48, 49), associated with the 25 adjusting elements, are embodied on the tool carrier (1), at which contact points, when the tool holder (3) is inserted into the receptacle (4, 5), its adjusting elements rest with a precise fit. The adjusting means (38, etc.) on the tool holder (3) are associated with the adjusting elements (26), by which adjusting means the adjusting elements are adjustable in the sense of the dimensionally precise adjustment of the angular position and/or axial position of the tool holder (3) relative to the axis of the receptacle.

At least two spaced-apart adjusting elements guided without play are provided on the tool holder, while at least two contact points associated with these adjusting elements are embodied on the tool carrier. When the tool holder is inserted in the receptacle, its adjusting elements rest with precise fit on the contact points. The adjusting elements are assigned adjusting means on the tool holder, by which they are adjustable in the sense of dimensionally precise adjustment of the angular position and/or axial position of the tool holder with respect to the axis of the receptacle. The contact points and/or the adjusting elements can be embodied in their parts that cooperate with the contact points in such a way that a two-dimensional or area type contact results, or that a two-dimensional/one-dimensional or area/linear contact results.

In a preferred embodiment, the contact points are embodied on a wall of at least one receiving groove of the tool carrier, which as a rule is located in the region of the bearing face for the tool holder. A receiving groove of this kind can be manufactured precisely using comparatively simple means; it does not hinder the function of the tool carrier, nor does it require any additional space. In a simple version, it is rectangular in cross section, but other cross-sectional profiles such as V-shaped profiles are fundamentally also possible; the adjusting elements are designed, in their parts that rest on a groove wall, to suit the groove shape. In grooves with parallel walls, they are advantageously embodied as precise-fit sliding blocks, while in the case of V-shaped grooves, for instance, a prismatic or wedge-shaped design on the adjusting elements in their engagement region with the groove wall can be considered.

Even with two adjusting elements that rest with a precise fit, spaced apart from one another, on contact points, for instance in a receiving groove of the tool carrier, a fixation of the angular position of the tool holder that can be reproduced with very close tolerances is assured. Depending on the requirements of a given intended use, it is also possible for more than two spaced-apart adjusting elements to be provided on the tool carrier, distributed annularly about the axis of the tool holder. For instance, two intersecting receiving grooves can be present in the tool carrier, whose point of intersection, in the case of a tool holder with a shaft and receptacle in the form of a bore, is located in regions of the receiving bore. Four adjusting elements are present on the tool carrier, resulting in four spaced-apart contact points. It is thus possible with high accuracy to adjust or correct not only the angular position of the tool holder relative to the tool carrier but also the location of the axis of the tool holder relative to the axis of the receptacle (lateral axial offset). Especially in applications in which the only need is to adjust or correct the axial offset, a single circular receiving groove in the tool carrier could suffice.

Once the tool holder has been inserted into the receptacle of the tool carrier, its adjusting elements rest with a certain prestressing on the contact points. In a preferred embodiment, this is achieved by prestressing means, which press adjusting elements, guided displaceably in guides of the tool carrier, against contact points without play.

To that end, in a corresponding embodiment of the tool holder with a shaft, the tool holder can be embodied with precentering, to which end precentering means are associated with the shaft of the tool holder; by these precentering means, at least part of the shaft is capable of being pressed elastically on one side, radially against the wall of the receiving bore receiving it. This creates especially simple structural conditions, because these precentering or prestressing means are embodied by an elastic toroidal ring, which as a rule is present anyway for sealing off the shaft from the wall of the receiving bore and which here is received on a bearing face that is eccentric to the longitudinal axis of the shaft, the bearing face as a rule being the bottom of the groove of the shaft for the toroidal ring. With the thus-achieved contact of the suitably preadjusted adjusting element with the contact point, for instance on the wall of the receiving groove, the fitting play between the adjusting element and the walls of the 15 receiving groove is no longer significant, thus minimizing angular deviations in tool holder changing.

The novel tool chucking fixture allows a play-free transmission of the angular position of the tool holder with a defined prestressing; if necessary, an axial offset between the tool holder and the receptacle can also be taken into account. The fixture can be produced with high precision at reasonable expense, because the receiving grooves, for instance, can be machined very precisely into the tool carrier without requiring excessive effort and expense. The adjusting elements present on the tool holder allow accurate adjustment (in the range below 0.01 mm), which in cooperation with the contact points provided on the tool carrier make it possible to compensate perfectly for production variations.

Finally, the tool holder can be preadjusted perfectly on a receptacle corresponding to the tool carrier. On a tool change, replicable conditions are obtained with respect to the positional accuracy, which in practice means for instance that for a tool tip of a transversely fastened tool, which is located at a distance of 150 mm from the axis or the receiving bore, a replicable accuracy with a tolerance of +0.01 mm is attainable.

### BRIEF DESCRIPTION OF THE DRAWINGS

FIG. 1 shows a tool chucking fixture according to the invention, having a tool holder and a tool carrier in the form of a star-type turret disk, shown in a schematic plan view;

FIG. 2 shows the tool carrier of the tool chucking fixture of FIG. 1, in a view taken along the line II-II of FIG. 1, in a detail showing a bearing face for a tool holder;

FIG. 3 shows the tool holder of the tool chucking fixture of FIG. 1, in greater detail, in axial section in a side view;

FIG. 4 shows the tool holder of FIG. 3, in a plan view;

FIG. 5 shows the tool holder of FIG. 3, in a side view from its collet;

FIG. 6 shows the tool holder of FIG. 4, inserted into a receiving bore of the tool carrier of FIG. 1, in a fragmentary view corresponding to FIG. 4;

FIG. 7 shows a detail of the tool holder of FIG. 6, showing an adjusting element in axial section, in a side view and on a different scale;

FIG. 8 shows a tool holder for a tool chucking fixture of the invention in a modified embodiment, in an axial view;

FIG. 9 shows the tool holder of FIG. 8 in plan view;

FIG. 10 shows the tool holder of FIG. 8, in a view from the side of the shaft;

FIG. 11 shows a tool holder for a tool chucking fixture of the invention, in a second embodiment for fixed tools, seen in plan view and on a different scale;

FIG. 12 shows the tool holder of FIG. 11, in a section taken along the line XII-XII of FIG. 11, in a side view;

FIG. 13 shows the tool holder of FIG. 1, in a view seen from the side of the shaft; and

FIG. 14 shows a detail of the tool holder of FIG. 11, showing an adjusting element in axial section, in plan view and on a different scale.

### DETAILED DESCRIPTION OF THE DRAWINGS

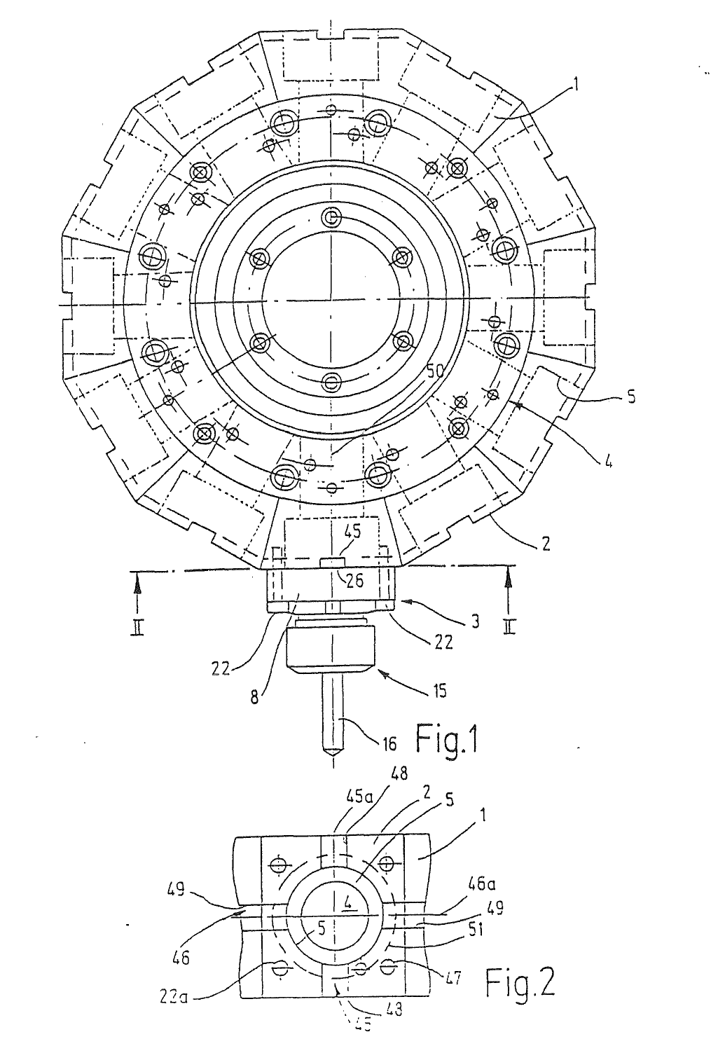

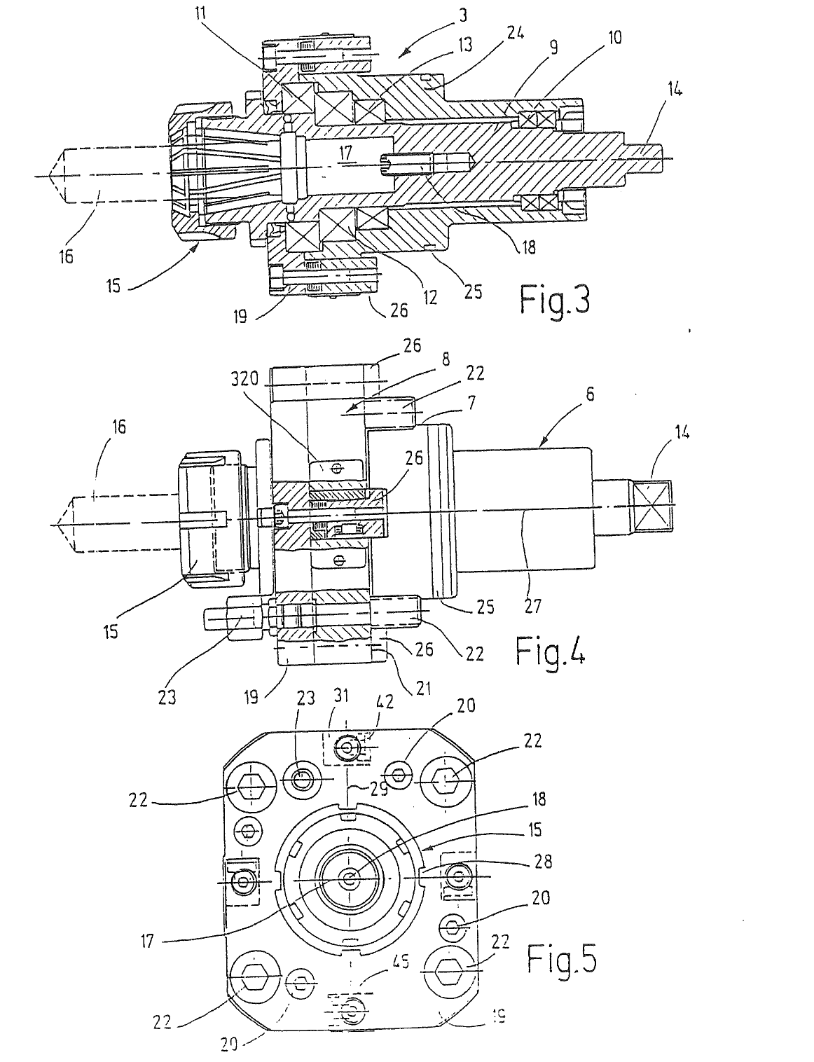

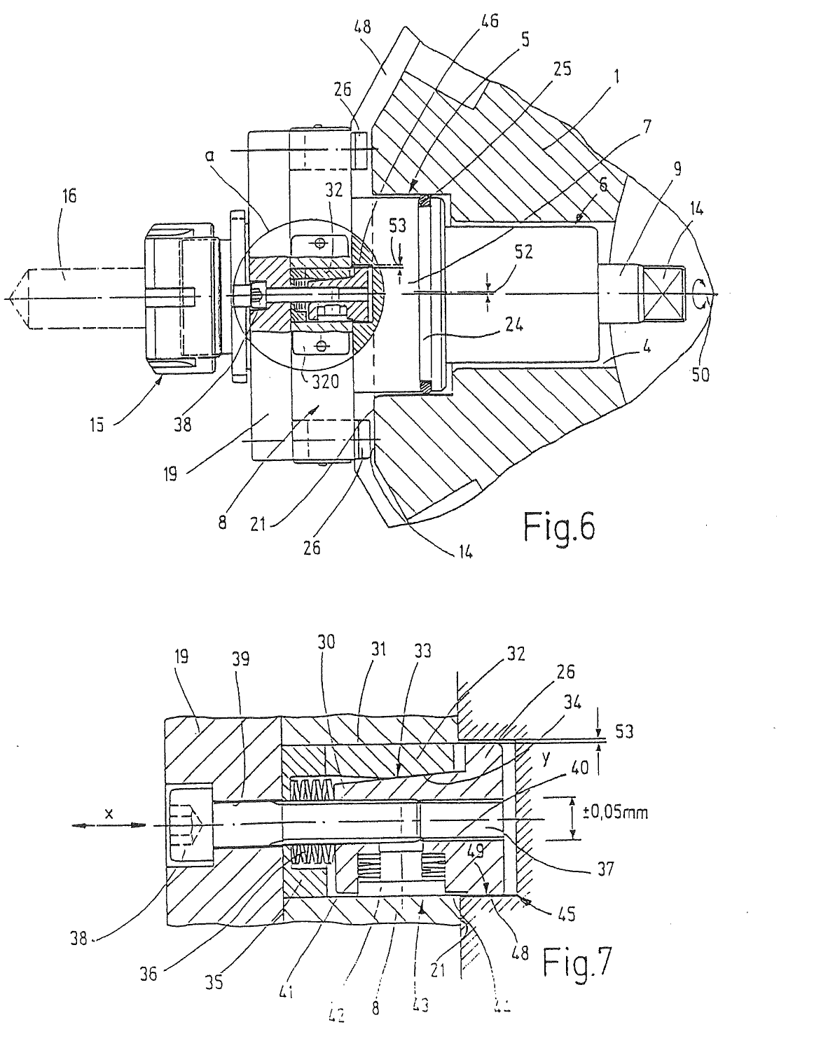

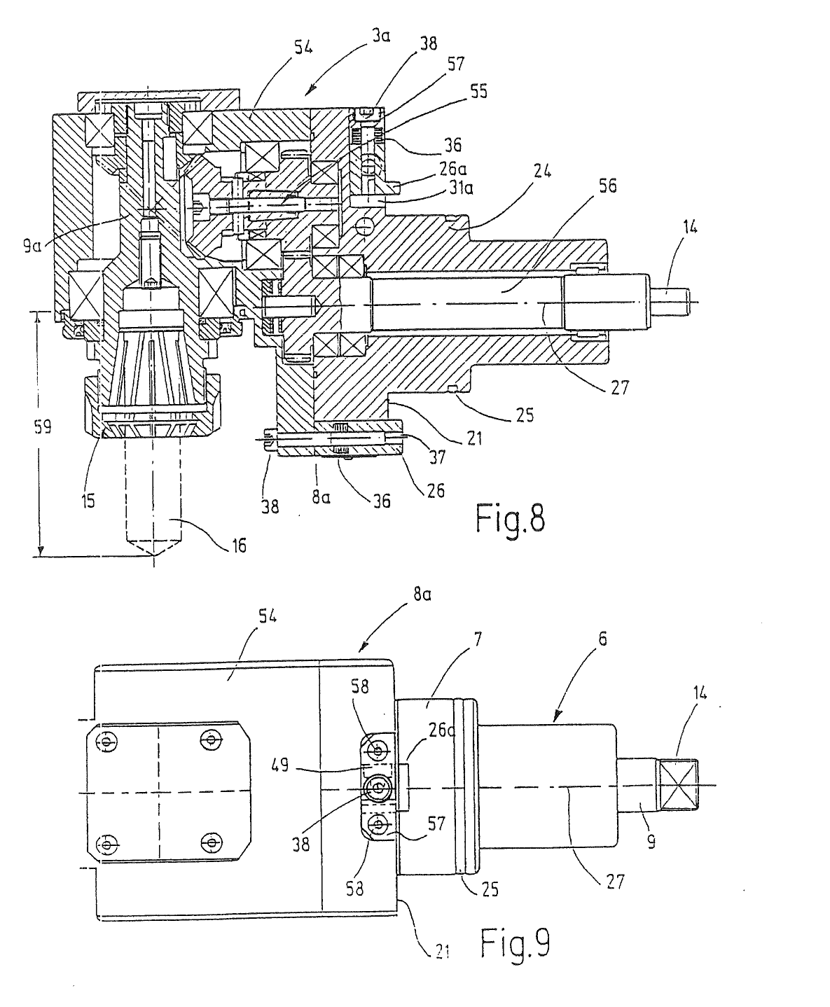

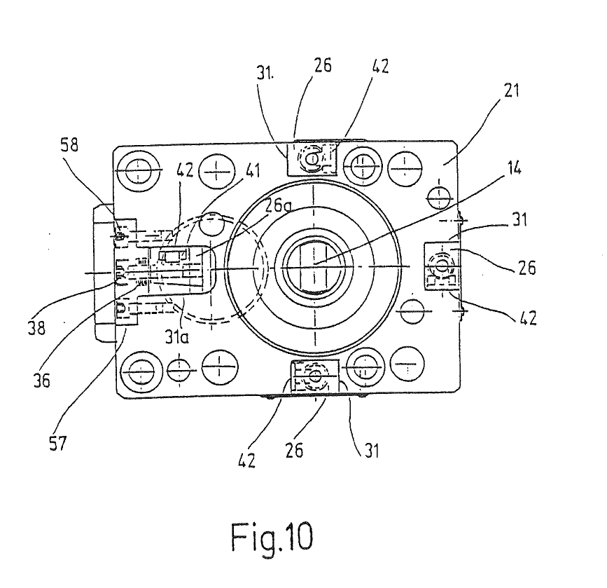

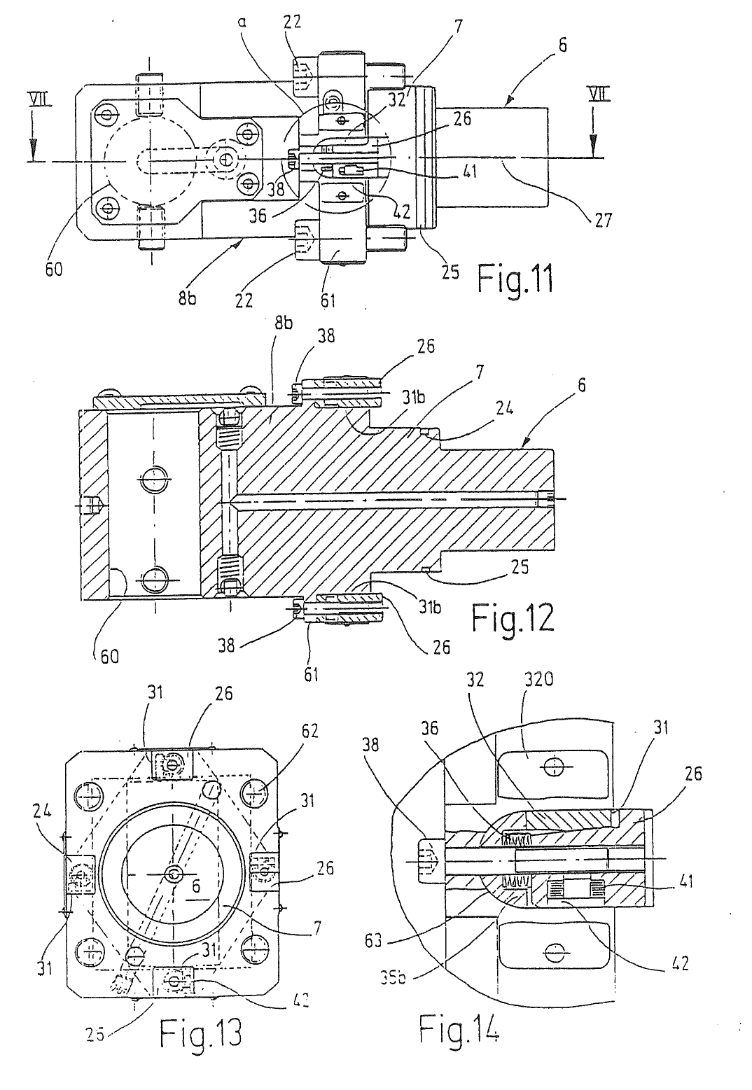

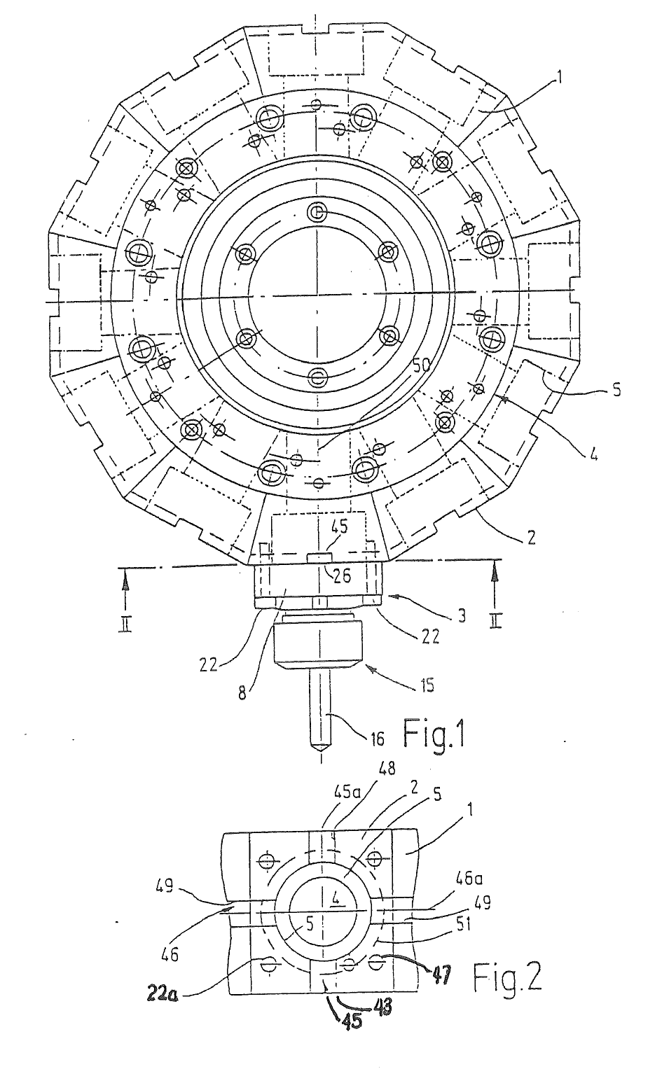

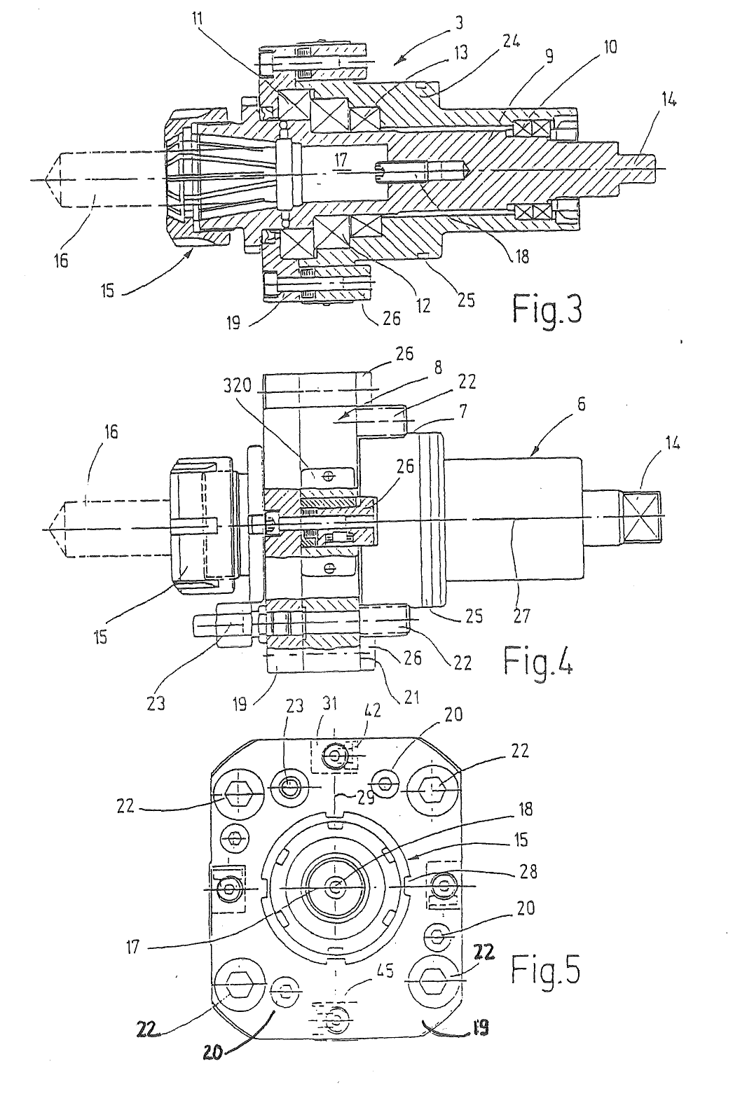

The tool chucking fixture shown in FIG. 1 has a tool carrier 1 in the form of a turret disk, which is part of a known star-type tool turret, not further shown, with radially arranged tools. The tool carrier 1 is embodied as a regular polygon, and on its circumference, it has flat bearing faces 2 for tool holders, one of which is schematically indicated at 3. In the region of each bearing face 2, the tool carrier 1 is provided with a radially oriented cylindrical receiving bore 4, which is embodied as a stepped bore, with a cylindrical portion 5 adjoining the bearing face 2, and which forms a receptacle for a tool holder 3. As seen from FIGS. 3 and 4, for instance, the tool holder 3 has a cylindrical shaft 6, which is embodied with a cylindrical guide portion 7 of larger diameter, and which when the tool holder 3 is inserted in the tool carrier 1 is. received in the associated receiving bore 4, or in the portion 5 thereof. The shaft 6 carries a housing 8, in which a spindle 9, which is coaxial to the shaft 6, is rotatably supported via roller bearings 10, 11, 12, 13. The spindle 9 is embodied on one end with a coupling 14 for a drive source, provided in the region of the tool carrier 1, and on its other end, it is provided with a collet 15 for clamping a tool, such as a drill, that is suggested at 16. The tool 16 is received in a tool receptacle 17 of the spindle 9 and is axially braced against an adjusting screw 18. The housing 8 is embodied in two parts; one part is formed onto the shaft portion 7, and the other part, in the form of a cap 19, is screwed to the first part by means of hexagonal socket screws 20 (FIG. 5). The arrangement is made such that a flange portion, protruding laterally past the shaft portion 7, is created that has a flat bearing face 21, with which the inserted tool holder rests on the bearing face 2 of the tool carrier 1, and in the region of which four fastening screws 22 are provided, by means of which the tool holder 3 is screwed via its flangelike part to the tool carrier 1.

Finally, a connection line for supplying coolant or lubricant is also suggested at 23. An annular groove 24 is provided in the shaft portion 7, and an elastic toroidal ring (0-ring) 25 is provided in the groove, which once the tool holder has been inserted seals off the shaft 6 from the receiving bore 4.

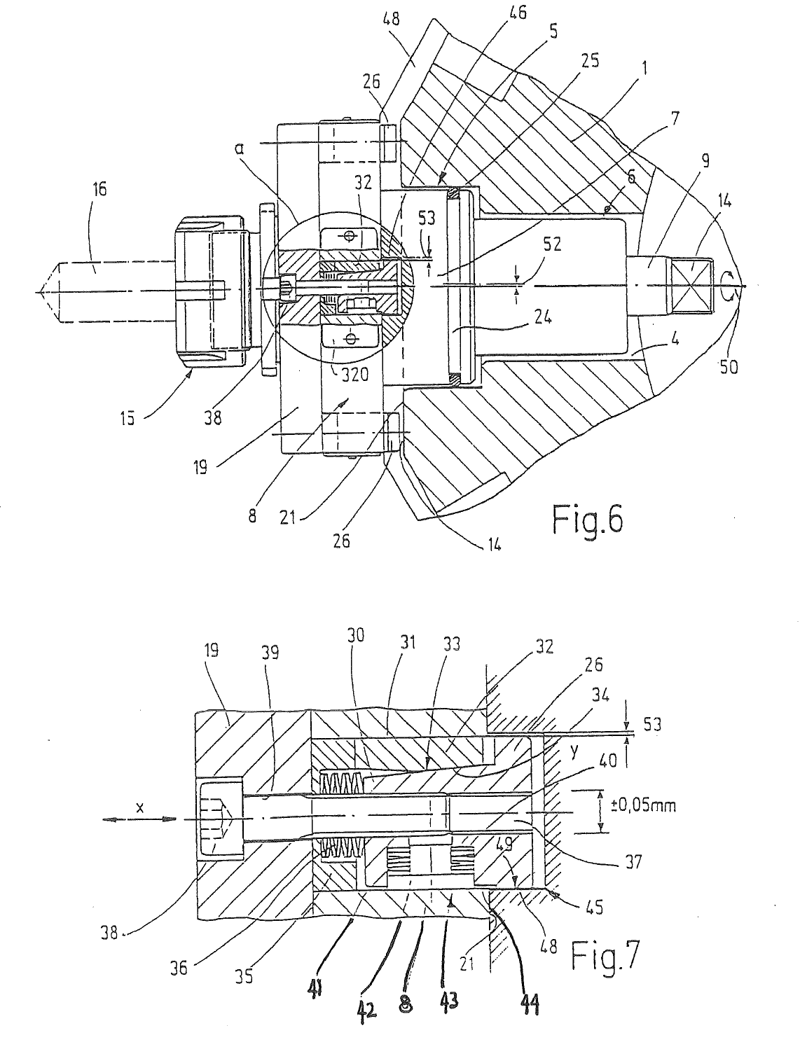

According to the invention, four adjusting elements in the form of sliding blocks 26 are provided in the housing 8 of the tool holder 3, distributed uniformly annularly around the axis 27 of the shaft 6. The sliding blocks 26 are each located in pairs on two diameters 28, 29 perpendicular to one another, as shown in FIG. 5, and they protrude axially past the bearing face 21 of the tool holder 3. The sliding blocks 26 are essentially rectangular in cross section (see FIGS. 4, 5) and are embodied with a formed-on guide part 30, with 5 which they are each received in a groovelike guide 31 of the housing 8; this guide is rectangular in cross section, parallel to the axis 27 of the shaft, and covered toward the outside by a screwed-on cover plate 320 (FIG. 4). As seen particularly from the detailed view of FIG. 6, which shows a detail inside the circle “a” shown in FIG. 7, a pressure plate 32 with a wedgelike or oblique face 33 inclined toward the outside is inserted into the groovelike guide 31 of rectangular cross section bounded by parallel flanks; this oblique face, together with a corresponding wedgelike face 34 embodied on the guide part 30, forms a wedge actuated mechanism. In the axial direction, the pressure plate 32 is braced against the cap 19 of the housing 8 via a spring sleeve 35. A cup spring assembly 36 is inserted into the spring sleeve 35 and prestresses the sliding block 26 in the direction represented in FIG. 6 by an arrow “x”, which points away from the bearing face 21. A hexagonal-socket adjusting screw 38 is screwed into a threaded bore 37 of the sliding block 26 and its guide part 30, the threaded bore being substantially coaxial with the longitudinal axis of the guide 31, and this screw extends through a bore 39 in the cap 19 and is adjustable from the front side of the tool holder 3.

On the side opposite the wedgelike face 34, a recess 40 is provided in the guide 30 of the sliding block 26, and a second cup spring assembly 41 is inserted into this recess, braced on a spring plate 42 guided displaceably in the recess 40 and pressed against the straight inner wall 43 of the guide 31, which wall is located opposite the wedgelike face 34. The guide part 30 is recessed in the regions at 44 located inside the guide 31 and facing toward the wedgelike face 34, so that the guide part 30 has a certain transverse mobility inside the guide 31.

The adjusting screw 38, the guide part 30 with the wedgelike face 34, and the pressure plate 32, together with the cup spring assemblies 36, 41 and the spring plate 42, form adjusting means for the sliding block 26. By rotation of the adjusting screw 38, the guide part 30, which with its wedgelike face 34 is pressed in prestressed fashion against the oblique face 33 of the pressure plate 32 and thus nonrotatably retained in the guide 31 by the spring plate 42 and the cup spring assembly 41, is displaced along with the sliding block 26 in the longitudinal direction “x” (FIG. 6), counter to the action of the prestressing exerted by the first Cup spring assembly 36. This cause a displacement of the sliding block 26 parallel to the inside face 45 (FIG. 5) of the guide 31, while at the same time the sliding block 26 executes a transverse motion, indicated by a double arrow “y” in FIG. 6. The adjusting range of this transverse motion is on the order of ±0.05 mm, for instance, as will be described hereinafter. The sliding blocks 26 are machined very precisely in their dimensions, in the form of precision sliding blocks. Via the wedge actuated mechanism 33/34, a very precise, sensitive adjustment in the “y” direction is obtained, while at the same time the adjusting means are self-locking, so that once a setting of the sliding block 26 has been established via the adjusting screw 38, it is maintained dimensionally precisely.

As can be seen particularly from FIGS. 1, 2, in the region of each of the bearing faces 2 of the tool carrier 1, there are two receiving grooves 45, 46, of rectangular cross section and bounded by parallel flanks, which intersect at right angles in the region of the receiving bore 4 in such a way that the point of intersection of the groove axes 45a, 46a is located on the axis 50 of the receiving bore 4. The receiving grooves 45, 46, which can also be called fitted keyways, receive the four sliding blocks 26 of the tool holder 3, when the tool holder 3 is secured to the tool carrier 1 via the fastening screws 22 and the associated threaded bores 46.

The dimensions of the precision sliding blocks 26 are 10 adapted to the width of the receiving grooves 45, 46 in such a way that the sliding blocks 26, when the tool holder 3 is mounted on the tool carrier, have only a slight fitting play, on the order of magnitude of about 0.02 mm. FIG. 5 shows that the four sliding blocks 26 of the tool holder 3 are 15 arranged in such a way that each two opposed sliding blocks 26 engage a respective receiving groove 45 and 46; the sliding blocks 26 are oriented in such a way that the spring plates 42 of adjacent guides 31 are always located on the same side, in clockwise terms.

Once the tool holder 3 has been mounted on the tool carrier 1, the sliding blocks 26 rest, with the bearing face 49 opposite the pressure plate 32, with a precise fit on the side wall 48 of the groove 45, or the corresponding side wall 49 of the groove 46 (FIGS. 2, 7), the side walls each forming a dimensionally precise, flat contact point. In accordance with The orientation of the sliding blocks 26 in the tool holder 3 as described in conjunction with FIG. 5, this creates two contact points in each of the receiving grooves 45, 45; the contact points are located on both sides of the axis 50 of the receiving bore, on opposed side walls 48 and 49 of the respective receiving groove 45 and 46. By suitable adjustment of the four adjusting screws 38, the four sliding blocks 26 can be moved in the “y” direction of FIG. 7 over an adjusting path corresponding at least to the fitting play between the sliding blocks 26 and the receiving grooves 45, 46. This adjusting motion makes it possible, via the sliding blocks 26 and the receiving grooves 45, 46, not only to adjust the angular position of the tool holder 3 relative to the tool carrier 1 sensitively with maximal precision but also to displace the axis 27 of the shaft 6 and thus of the tool 16 of the tool holder 3 laterally relative to the axis 50 of the receiving bore 4, and thus to set or correct an axial offset, for instance to compensate for production variations. The tool holder 3 can thus be centered on the receiving grooves 45, 46 via the precision sliding blocks 26 and can be adjusted and calibrated precisely relative to the tool carrier 1.

In practice, the tool holders 3 are preadjusted on a receptacle corresponding to the tool carrier 1. This preadjustment is exactly replicable, so that the angular position and any axial offset can be transmitted without play once the tool holder 3 is inserted into the receptacle of the tool carrier 1.

Instead of the sliding blocks 26 of rectangular cross section described, which are manufactured as precision sliding blocks, for instance with an 18H6 fit, differently embodied adjusting elements can also be used, which for instance produce a linear contact at the contact point on the side walls 48, 49 of the grooves. The contact points also need not be provided on side walls of the grooves. In principle, the receiving grooves can also be located on indentations, protrusions, or other suitable construction elements, depending on the given construction of the tool carrier. If all that is needed is to calibrate to the angular position of the tool holder, then as a rule two contact points and one receiving groove 45 or 46 are sufficient, while in cases where only an axial offset between the shaft 6 and the receiving bore 4 has to be calibrated or corrected, then even one circular receiving groove or receiving indentation concentric with the axis 50 of the receiving bore 4 might suffice, as indicated by dashed lines at 51 in FIG. 2.

In FIG. 6, the tool holder of FIG. 3 is shown in the built-in state; the paired contact of the precision sliding blocks 29 with the contact points of the side walls 48 of the receiving groove 45 is shown. The elastic toroidal ring 25 that seals off the shaft portion 7 of the tool holder 3 from the portion of the receiving bore 4 is simultaneously 1.5 utilized to achieve precentering of the tool holder 3 relative to the tool carrier I during assembly. To that end, the annular groove 24 that receives the toroidal ring 25 is embodied as eccentrically offset, by the amount 52 which for the sake of clarity is not shown to scale in FIG. 7, relative to the axis 50 and the receiving bore 4. As a result, it is attained that the toroidal ring 25 is compressed more markedly over part of its circumference, with the consequence that the sliding blocks 26 are pressed against the side walls of the groove with an elastic prestressing that is generated by the toroidal ring 25. The diameter of the shaft portion 7 is somewhat less than the diameter of the receiving bore portion 5, to enable compensation to the precise location of the tool holder 3 relative to the tool carrier I. With this prestressing, with which the sliding blocks 26 are pressed against their contact points, the fitting or assembly play 53, shown in exaggerated size at 53 in FIGS. 6 and 7, for the positional setting of the tool holder 3 is no longer significant, so that when the fastening screws 22 are tightened, the tool holder exactly assumes the preset position relative to the tool carrier 1.

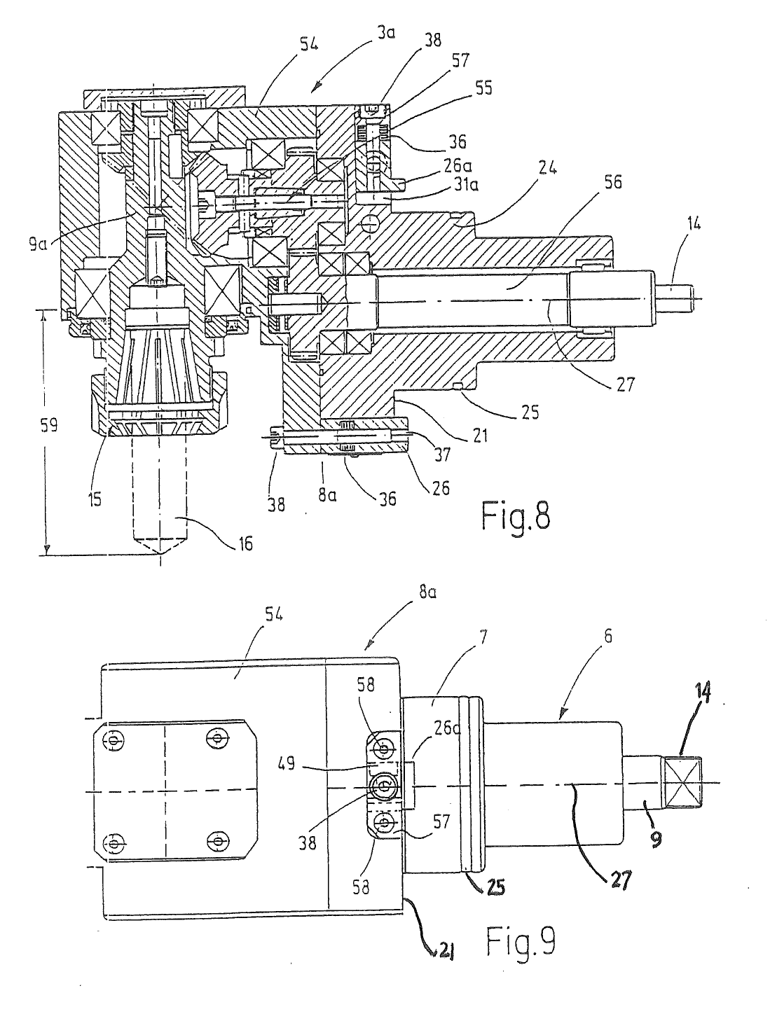

An exact calibration of the angular position of the tool holder relative to the tool carrier is necessary 5 particularly whenever the tool holder receives tools that: extend crosswise to the shaft axis and have a considerable length. One example of this is shown in FIGS. 8-10, where a tool holder 3a with a transverse receptacle for the tool 16 is shown. The tool holder 3a is constructed fundamentally 10 similarly to the tool holder 3 already explained in conjunction with FIGS. 1-7. Identical elements are therefore identified by the same reference numerals and not explained again. Essentially the only difference is that the housing 8a, instead of the cap 19 of FIG. 3, has a gearbox 54, in 15 which, via a bevel gear 55, the spindle 9a that carries the collet 15 and the tool 16 is rotatably supported with an axial direction oriented perpendicular to the axis 27. The drive Of the spindle 9a is effected via a shaft 56, which is rotatably supported in the shaft 6 and in turn carries the coupling 14. The details of the bevel gear 55 and the spindle bearing are known and need not be described in further detail here.

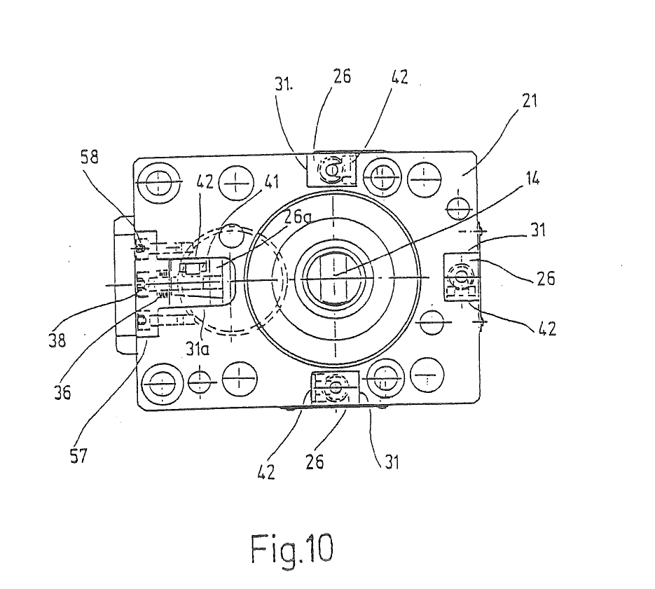

As seen particularly from FIG. 10, the tool holder 3a again has four adjusting elements, distributed uniformly 25 around the axis 27, which engage the receiving grooves 45, 46 of the tool carrier 1. These adjusting elements are again embodied as precision sliding blocks 26, 26a, of which three sliding blocks 26 correspond to the sliding blocks 26 in the embodiment of FIGS. 1-7. The fourth sliding block 26a, 30 however, is substantially L-shaped, as seen particularly in FIGS. 8, 9. The sliding blocks 26, 26a are guided in guides 31, 31a of the housing 8a in the manner already described and can be adjusted via adjusting screws 38 in the manner explained in conjunction with FIG. 7. While the adjusting screws 38 of the sliding blocks 26, located in the flangelike part of the housing 8a, are easily accessible from outside 5 for their actuation (FIGS. 8, 9), placing the adjusting screws 38 of these sliding blocks 26 parallel to the axis 27, in the region of the gearbox 54, would lead to difficulties in terms of accessibility. For this reason, in this region, the guide 31a in the flangelike portion of the housing 8a is oriented at right angles to the axis 27, so that the adjusting screw 38 is accessible from the circumferential side of the housing 8a. The sliding block 26a, which because of its L-shaped design protrudes axially past the bearing face 21 otherwise cooperates, in the same way as the sliding blocks 26, with its associated contact point in one of the receiving grooves 45, 46. Toward the circumferential side, the guide 31a is closed by a flange piece 57, inserted into a corresponding indentation in the flangelike housing part, which piece is anchored via screws 58 (FIG. 10), and in which the spring sleeve 35 of FIG. 7 is also embodied.

The tool length suggested at 59 in FIG. 8 makes it understandable that even slight errors in the angular position of the tool holder 3a lead to considerable lateral positional errors of the tool tip. With the presetting of 25 the precision sliding blocks 26, 26a that has been described at length and with the prestressing generated by the toroidal ring 25 as also already explained, the fitting play becomes insignificant during assembly, and thus positional errors of the tool tip upon a change of tool holder are minimized.

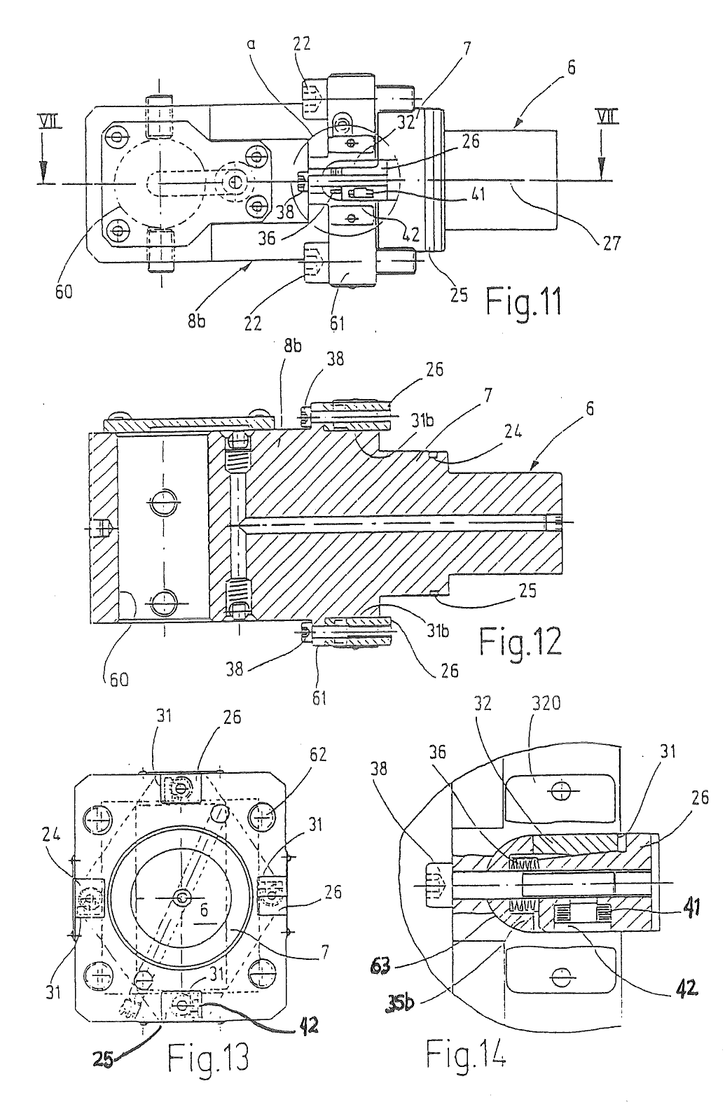

The tool chucking fixture described is suitable not merely for tool holders 3, 3a with driven tools. It can also be used for any kind of tool holders. Thus FIGS. 11-14, as an example, also show a tool holder 3b for a nondriven tool, namely a drill rod not otherwise shown. Elements identical to the embodiments 3, 3a already described are again provided with the same reference numerals and will not be explained again. The tool holder housing 8b is embodied integrally with the cylindrical shaft 6 and has a transversely extending receptacle 60 for a drill rod. Four guides 31 with associated precision sliding blocks 26 are provided in the housing 8a, which as shown in FIG. 13 are distributed uniformly about the axis 27 of the shaft, in a manner similar to that of FIG. 5. The guides 31 are accommodated in a flangalike part 61 of the housing 8b, in which the bores 62 for the fastening screws 22 (FIG. 1) are also located. FIG. 14 shows that the guides 31 are again embodied in the manner of rectangular grooves, which for production reasons are closed off on one face end by a cylindrical surface 63. Accordingly, the shape of the spring sleeve 35b is suitably adapted.

Alternatively, the flangelike housing part 61 could also be replaced with its own flange joined to the housing 8b, and this applies to all the tool holders 3, 3a, 3b.

1. A tool chucking fixture, having a tool holder that receives a tool and is intended for insertion into a receptacle of a tool carrier, in particular of a lathe, in which the tool holder and the tool carrier have bearing faces associated with one another and devices for securing the tool holder to the tool carrier, and positioning means for positionally precise adjustment of the tool holder relative to the receiving bore are provided, characterized in that the tool holder (3) has at least two adjusting elements (26), guided without play and spaced apart from on another; that at least two contact points (48, 49), associated with the adjusting elements, are embodied on the tool carrier (1), at which contact points, when the tool holder (3) is inserted into the receptacle (4, 5), its adjusting elements rest with a precise fit; and that the adjusting means (38, etc.) on the tool holder (3) are associated with the adjusting elements (26), by which adjusting means the adjusting elements are adjustable in the sense of the dimensionally precise adjustment of the angular position and/or axial position of the tool holder (3) relative to the axis of, the receptacle.

2. The tool chucking fixture of claim 1, characterized in that the length of the adjusting path of the adjusting elements for the positional adjustment of the tool holder (3), which has a shaft (6), lies at least within the assembly play (53) that exists between the shaft (6) of the tool holder and the inner wall of the receiving bore (4) associated with the shaft, and when the tool holder has been inserted, the adjusting elements rest in prestressed fashion on the contact points.

3. The tool chucking fixture of claim 1, characterized in that the contact points are distributed around the axis (50) of the receptacle (4).

4. The tool chucking fixture of claim 1, characterized in that the contact points are embodied on a wall (48; 49) of at least one receiving groove (45, 46) of the tool carrier (1).

5. The tool chucking fixture of claim 4, characterized in that the receiving groove (45, 46) is located extending transversely to the receptacle (4).

6. The tool chucking fixture of claim 4, characterized in that the contact points are embodied on groove walls (48, 49) of two intersecting receiving grooves (45, 46), whose intersecting point is located in the region of the receptacle (4).

7. The tool chucking fixture of claim 5, characterized in that the receiving groove (45, 46) is located with its longitudinal axis (45a; 46a) intersecting the axis (50) of the receptacle (4).

8. The tool chucking fixture of claim 1, characterized in that the contact points are embodied on a wall of a circular-annularly embodied receiving groove (51) of the tool carrier (1).

9. The tool chucking fixture of claim 1, characterized in that it has four adjusting elements (26) in the tool holder (3) and four contact points, associated with them, on the tool carrier (1), which are distributed annularly about the axis of the receptacle (4).

10. The tool chucking fixture of claim 1, characterized in that bearing faces for the adjusting elements (26) are present at the contact points.

11. The tool chucking fixture of claim 1, characterized in that the adjusting elements (26) are guided displaceably in guides (31) of the tool carrier (1), and the adjusting means (38, etc.) are embodied as actuatable from the outside of the tool holder (3).

12. The tool chucking fixture of claim 11, characterized in that the adjusting elements (26) are guided in the tool holder (3) in a manner secured against relative rotation.

13. The tool chucking fixture of claim 11, characterized in that the adjusting elements have a wedge actuated mechanism (33/34), cooperating with the respective adjusting element, by which a displacement (“x”), oriented in the longitudinal direction of the adjusting element (26), of the adjusting element in its guide (31) can be converted into an adjusting motion (“y”), oriented transversely thereto, of at least a part of the adjusting element.

14. The tool chucking fixture of claim 13, characterized in that the adjusting element (26) is prestressed resiliently in its guide (31).

15. The tool chucking fixture of claim 13, characterized in that the (26) is pressed without play against a guide face (33) in its guide by spring means (41).

16. The tool chucking fixture of claim 15, characterized in that the adjusting element (26) is resiliently prestressed by first spring means (26) in its displacement direction and by second spring means (42) against the lateral guide face (33).

17. The tool chucking fixture of claim 11, characterized in that the adjusting element (26) is embodied, at least in a region protruding past the bearing face of the tool holder, as a sliding block, whose dimensions are adapted to the dimensions of an associated receiving groove (45, 46) in the tool carrier (1).

18. The tool chucking fixture of claim 1, characterized in that the adjusting element have an adjusting screw (38) that can be actuated from the outside of the tool holder.

19. The tool chucking fixture of claim 11, characterized in that the adjusting element (26a) is substantially L-shaped.

20. The tool chucking fixture of claim 1, characterized in that the tool holder (3) has a shaft (6), and precentering means (25) are associated with the shaft (6) of the tool holder (3), by which precentering means at least a portion (7) of the shaft can be pressed elastically, unilaterally radially, against the wall of a receiving bore (4, 5), receiving it, in the tool carrier (1).

21. The tool chucking fixture of claim 20, characterized in that the precentering means are formed by an elastic toroidal ring (25), which is received on a bearing face of the shaft (6) that is eccentric to the longitudinal 5 axis of the shaft.

22. The tool chucking fixture of claim 1, characterized in that the tool carrier (1) is part of a tool turret.

23. The tool chucking fixture of claim 1, characterized in that the tool carrier (1) is part of a machine table or is arranged for use on holding or chucking devices on machine tables.
